(19) United States
(12) Patent Application Publication
(10) Pub. No.: US 2014/0337404 A1
(43) Pub. Date: Nov. 13, 2014

(54) SYSTEM AND METHOD FOR PROVIDING ACCESS POINTS

(71) Applicants: John Nicholas Jitkoff, Palo Alto, CA (US); Glen Murphy, Palo Alto, CA (US)

(72) Inventors: John Nicholas Jitkoff, Palo Alto, CA (US); Glen Murphy, Palo Alto, CA (US)

(73) Assignee: Google Inc., Mountain View, CA (US)

(21) Appl. No.: 13/409,010

(22) Filed: Feb. 29, 2012

(51) Int. Cl. G06F 15/16

(52) U.S. Cl. 709/203

(57) ABSTRACT

A method for providing a dynamic system-generated set of access points to a user including determining at least one web application or one web page to include within a set of access points according to a set of criteria, generating an access point for the determined web application or one web page, adding the generated access point to the set of access points such that the set of access points includes at least one access point corresponding to a web page and at least one access point corresponding to a web application and providing the set of access points for display to a user in a first page of a web browser.

### BACKGROUND

When interacting with a web browser, users create short cuts to different web pages or web applications for easier future access. These short cuts, referred to as access points, may be stored as book marks or short cut icons.

In a web browser, access points to web pages (e.g., bookmarks) are typically separated from access points to web applications (e.g., icons or other suitable links). This may be inconvenient to a user of the web browser, especially if the user visits web pages and uses web applications frequently. Separating the access points to web pages from the access points to web applications may slow down the user's experience with the web browser.

### SUMMARY

The disclosed subject matter relates to a machine-implemented method for providing a dynamic system-generated set of access points to a user, the method comprising determining at least one web application or one web page to include within a set of access points according to a set of criteria, the set of criteria including whether the at least one web page or web application belongs in one or more categories, each category including one or more web pages or web applications assigned to the category based on information regarding user behavior with respect to one or more web pages or web applications. The method further comprising generating an access point for the determined at least one web application or one web page. The method further comprising adding the generated access point to the set of access points such that the set of access points includes at least one access point corresponding to a web page selected according to the set of criteria and at least one access point corresponding to a web application selected according to the set of criteria and providing the set of access points for display to a user in a first page of a web browser.

The disclosed subject matter also relates to a system for optimizing the displaying of a rich web document to a user, the system comprising one or more processors and a machine-readable medium comprising instructions stored therein, which when executed by the processors, cause the processors to perform operations comprising determining at least one web application and one web page to include within a set of access points, wherein the at least one web page and one web application each belong in one or more categories, each category including one or more web pages or web applications assigned to the category based on information regarding user behavior with respect to one or more web pages or web applications. The operations further comprising generating an access point for each of the determined at least one web application and one web page. The operations further comprising adding the generated access point to the set of access points such that the set of access points includes at least one access point corresponding to a web page selected according to the set of criteria and at least one access point corresponding to a web application selected according to the set of criteria and providing the set of access points for display to a user.

The disclosed subject matter also relates to a machine-readable medium comprising instructions stored therein, which when executed by a machine, cause the machine to perform operations comprising determining at least one web application and one web page to include within a set of access points according to a set of criteria, the set of criteria including whether the at least one web page or web application belongs in one or more categories, each category including one or more web pages or web applications assigned to the category based on information regarding user behavior with respect to each of the one or more web pages or web applications. The operations further comprising generating a first access point for the determined at least one web application. The operations further comprising generating a second access point for the determined at least one web page. The operations further comprising adding the generated access point to the set of access points such that the set of access points includes at least one access point corresponding to a web page selected according to the set of criteria and at least one access point corresponding to a web application selected according to the set of criteria and providing the set of access points for display to a user in a first page of a web browser, wherein the user is given limited control over the displayed set of access points.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for providing a dynamic system-generated set of access points.

FIG. 2 illustrates a flow diagram of an example process for providing a user with one or more sets of access points.

FIG. 3 illustrates a screen shot of an example graphical user interface displaying a web browser displaying a main page including a set of access points.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details.

In some instances, well-known structures and components are shown in block diagram form in order to avoid obscuring the concepts of the subject technology.

The subject disclosure provides a user of a web browser with convenient access to both web pages and web applications. In some aspects, access points to web pages (e.g., an icon providing a link to the webpage or a bookmark) and access points to web applications (e.g., an icon providing a link to the webpage or a bookmark) may be displayed to the user under a single category in a single page of the web browser so that the user may have convenient access to both web pages and web applications. In one example, a web browser may include one or more tabs, each tab displaying one or more pages. In one example, at least a first page on a tab (e.g., a home page) may display a dynamic set of access points selected for the user based on the user activity.

The set of access points may be selected by the system based on user activity and may for example include access points to web applications and web pages which were most visited, recently used and/or recently closed. The most visited access points include web pages or web applications that are most frequently visited by the user. Recently used web pages or web applications refer to those web pages or web applications that were closed by the user within a pre-determined period of time. Recently used web pages or web applications refer to those that were used by the user (e.g., accessed and/or viewed) within a predetermined period of time. The access points displayed in this page of the web browser may be updated dynamically without the user's input depending on the category. The subject technology is not limited to the most visited, recently used or the recently closed web page or web applications, but may include other suitable categories such as a most popular category (either among general users or among the user's friends and/or families), a recently updated category (showing web pages and/or web applications that were recently updated) and/or other similar categories.

In one example, a single set of access points may be selected including access points to web pages and web applications selected from the above discussed categories and/or a separate set of access points may be generated for each specific category of web pages and/or web applications (e.g., a set of access points of most visited web pages or web applications and a second set of access points of recently closed web pages or web applications). The set of access points for each category may be displayed within its own page, or multiple access points may be displayed within a single page. The number of access points displayed within the dynamic set of access points, and the type of access point (e.g., the category of access point) may depend on the user activity or user preferences as indicated by the user and/or system settings.

In some aspects, the dynamic page of the web browser may be used as the main page of the web browser. That is, each time a new instance of a tab or window of the browser is opened, the main page including the system-generated set of access points is displayed. According to certain aspects, the user may be provided with limited control of the access points displayed on the main page. For example, the user may be allowed to only rearrange the access points, delete the access points and/or replace the access points.

In addition to the dynamically created set of access points, the system further provides the user with the ability to generate additional sets of access points to web applications and web pages to display on or more additional pages (e.g., a secondary page that is different from the main page). In some aspects, the user may be provided with full control of the access points on the additional pages such that the user may create customized sets of access points to those web pages or browsers that the user would like to view. The secondary page may be a customized page of access points, wherein the user has full control of the access points displayed on the secondary page. For example, the user may create and/or modify any access points displayed on the additional pages.

As discussed herein, a web browser application (or “web application”) is a software program that is designed to be installed by a web browser and used within the web browser. Web applications can be, for example, hosted web applications or packaged web applications. A hosted web application includes data for a display of a normal website supplemented with extra metadata. The extra metadata provides a description of the application, including, for example, a name, description, version, relevant web addresses (e.g., URI addresses that the hosted web application uses), launch instructions, appearance data, icon information, unique identifier(s), compatible web browser information, and update information. Unlike hosted web applications, packaged web applications are downloadable and can therefore operate offline. Packaged web applications may also be integrated with a web browser because hosted web applications are configured to access web browser extensions. Web applications can be written using, for example, web technologies such as HyperText Markup Language (HTML), JavaScript, and Cascading Style Sheets (CSS). Packaged web applications can bundle all associated data into a single data file that the web browser downloads and installs. Thus, unlike hosted web applications, packaged web applications do not depend on an active network connection.

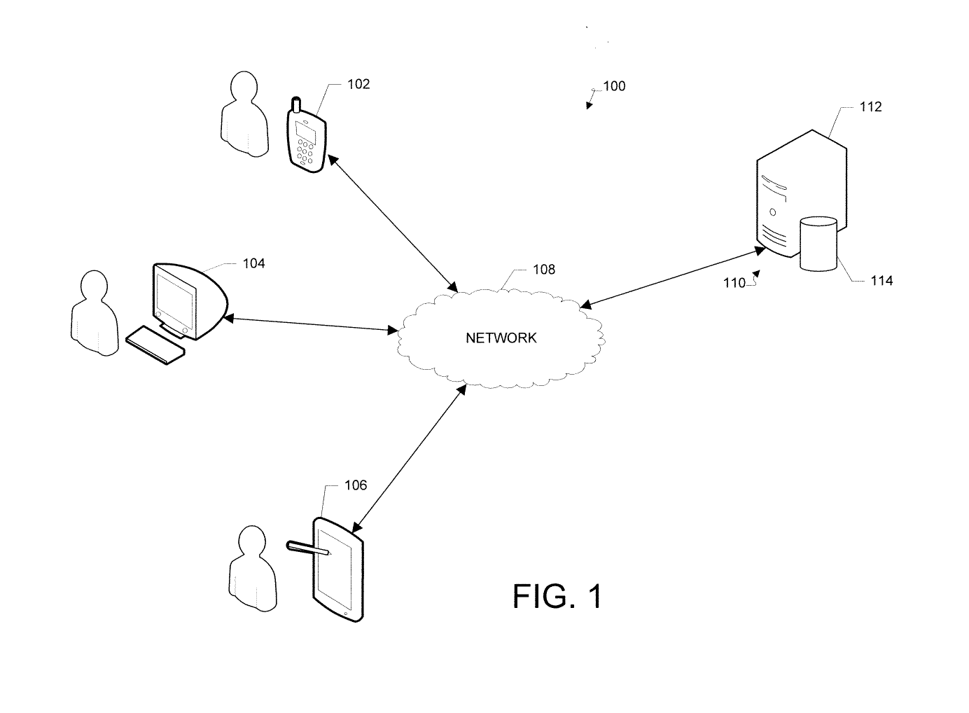

FIG. 1 illustrates an example client-server network environment which provides for providing a dynamic system-generated set of access points. A network environment 100 includes a number of electronic devices 102, 104 and 106 communicably connected to a server 110 by a network 108. Server 110 includes a processing device 112 and a data store 114. Processing device 112 executes computer instructions stored in data store 114, for example, to assist in dynamic system-generated set of access points at the electronic devices 102, 104 and 106.

In some example embodiments, electronic devices 102, 104 and 106 can be mobile or non-mobile computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In the example of FIG. 1, electronic device 102 is depicted as a smartphone, electronic device 104 is depicted as a desktop computer, and electronic device 106 is depicted as a PDA. Each of the electronic devices 102, 104 and 106 is configured to run a web browser as disclosed herein.

In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

In one example, a web browser running on a client device (e.g., client devices 102, 104 and 106) is configured to display one or more tabs or windows. In one example, each time the user opens a web browser or a tab within the browser, the browser displays a set of pages including a main page and/or one or more additional pages. Data for the web browser can be received at the client device over the network 108 from server 110. For purposes of load balancing, multiple servers 110 can host the data for the web browser. The servers 110 can be any device having an appropriate processor, memory, and communications capability for hosting the data. The data can include a set of access points for display within each of the main page and/or the one or more additional pages.

In one example, the set of access points displayed on the main page (e.g., the first page displayed to the user) may comprise a dynamic set of access points generated by the system (e.g., hosted at server 110) and may include one or more access points to one or more web pages and/or web applications. The set of access points may be selected from a number of web pages and web applications belonging to various categories of web pages and/or web applications. The categories of web pages and/or web applications may be maintained by the server 110 and may be based upon user behavior and/or behavior of other users (e.g., all internet users, users of a specific browser or contacts of the user). The categories of web applications may include one or more of most visited, recently used, recently closed, most popular, recently modified and/or other similar categories. The number and categories of access points to web pages or web applications included within the dynamic set(s) of access points may be determined based on one or more of user behavior and preferences and/or system or user settings. For example, a page may display one or more sets of access points, and each set may include access points belonging to one or more categories.

When a user interacting with a client device (e.g., electronic devices 102, 104 or 106) open a web browser or a tab within a web browser, the system may retrieve a main page including one or more dynamic sets of access points and may display the one or more dynamic sets within the main page of the web browser window or tab. In one example, the system may generate one or more dynamic sets and may display each set within a different page, or may provide a menu selection for allowing the user to select how the different sets are displayed. In one example, each dynamic set may include an access point to at least one web page and one web application. The displayed sets may be dynamically adjusted based on user behavior (e.g., periodically) without user interference.

In addition, the web browser window or tab may include one or more secondary pages displaying one or more user-generated sets of access points including one or more web pages and web applications. The access points for each user-generated set may be stored within a list of user-specific access point list stored at a data store (e.g., data store 114 accessible by server 110). The browser graphical user interface may provide mechanisms for allowing the user to navigate through the one or more pages displaying the one or more system-generated dynamic sets of access points and the one or more user-generated sets of access points.

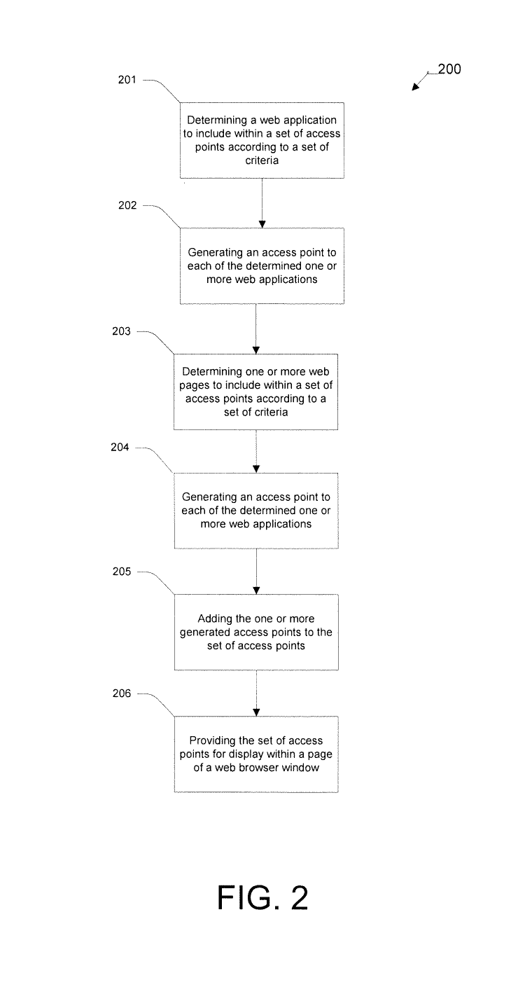

FIG. 2 illustrates a flow diagram of an example process 200 for providing a user with one or more sets of access points. In one example the access points may be displayed within a web browser (e.g., a web browser window or tab). In step 201, the system determines one or more web applications according to a set of criteria. As described above, the determined one or more web applications may be selected from one or more categories of web applications, where the web applications are determined to belong within each category according to user behavior.

The one or more categories may include most recently viewed or used web applications, recently closed web applications, most visited web applications (e.g., within a specific period of time, by the user or other users), most popular web applications (e.g., according to the user or other users), or other similar categories of web applications which may be significant for the user. In one example, the web applications are determined to belong to one or more categories and a score may be assigned to a web application according to the different categories it may belong to, to assess its significance (e.g., web applications having the highest score may be selected for inclusion within the set of access points).

In one example, web applications from one or more different categories may be selected for inclusion within the set of access points, or a separate set of access points may be generated for each category of web applications. In one example, the web applications may be assigned to the different categories and selected based on user behavior at the device running the web browser and/or at one or more devices associated with the user (e.g., other mobile or non-mobile devices where the user interacts with web applications). Similarly, the web applications may be selected based on user behavior at the specific web browser and/or across multiple browsers.

In step 202, the system generates an access point for each of the determined one or more web applications. In one example, the access point comprises a thumbnail or icon graphically representing the web application. The system may generate the access point by extracting the salient colors of an image representing the web application (e.g., the main page, thumbnail or other image representing the web application) and create a border around the access point including the salient colors.

In step 203, the system determines one or more web pages according to a set of criteria. As described above, the determined one or more web pages may be selected from one or more categories of web pages, where the web pages are determined to belong within each category according to user behavior.

The one or more categories may include most recently viewed or used web pages, recently closed web pages, most visited web pages (e.g., within a specific period of time, by the user or other users), most popular web pages (e.g., according to the user or other users), or other similar categories of web pages which may be significant for the user. In one example, the web pages are determined to belong to one or more categories and a score may be assigned to a web page according to the different categories it may belong to, to assess its significance. (e.g., web pages having the highest score may be selected for inclusion within the set of access points).

In one example, web pages from one or more different categories may be selected for inclusion within the set of access points, or a separate set of access points may be generated for each category of web pages. In one example, the web pages may be assigned to the different categories and selected based on user behavior at the device running the web browser and/or at one or more devices associated with the user (e.g., other mobile or non-mobile devices where the user interacts with web pages). Similarly, the web pages may be selected based on user behavior at the specific web browser and/or across multiple browsers.

In step 204, the system generates an access point for each of the determined one or more web pages. In one example, the access point comprises a thumbnail or icon graphically representing the web page. The system may generate the access point by extracting the salient colors of an image corresponding to the web page (e.g., the main page, thumbnail or other image representing the web page) and create a border around the access point including the salient colors.

In step 205, the one or more generate access points are combined to generate the set of access points. The set of access points may include at least one web page access point and one web application access point. The number of access points included within the set of access points may be based on a predetermined number (e.g., based on user or system settings) and/or may be based upon the user preferences as indicated from user behavior (e.g., past sets of access points, user-generated access points).

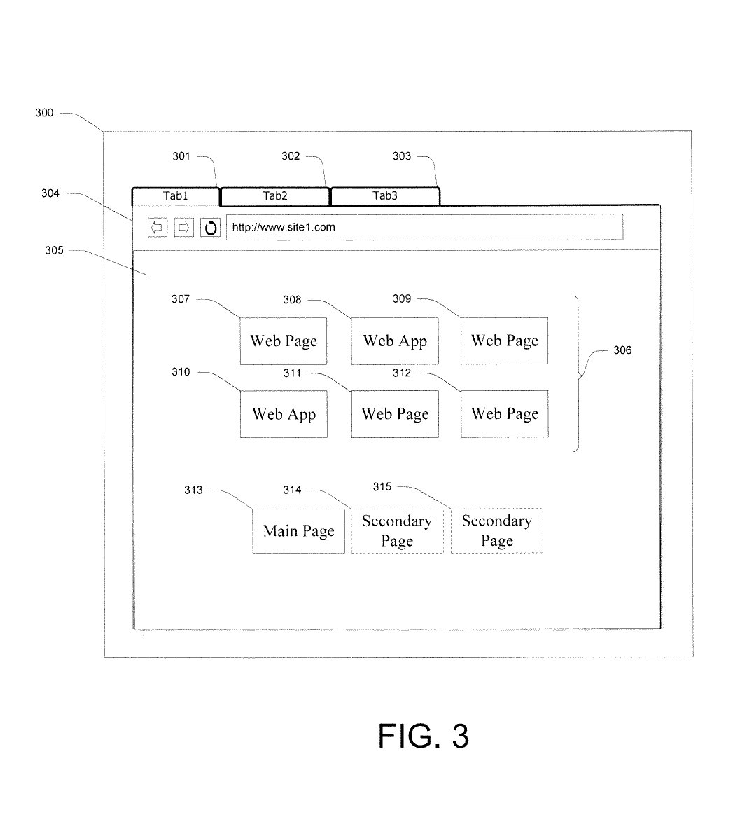

In step 206, the set of access points is provided for display within a page of a web browser (e.g., the main page of the browser window or tab). In one example, once displayed the set of access points may only be modified in a limited manner by the user. For example, the user may only be able to rearrange the order in which the access points may appear within the set. In another example, the user may also be able to delete and/or replace one or more access points within the set. In one example, the system may periodically and/or upon receiving indication of user activity (e.g., in the browser or another browser, at the client device or another device), update the set of access points by replacing one or more access points with new access points to one or more web pages or web applications. An example screen shot of a web browser window displaying a set of access points is described in more detail below with respect to FIG. 3.

FIG. 3 illustrates a screen shot of an example graphical user interface 300 displaying a web browser displaying a main page including a set of access points. Graphical user interface 300 displays a web browser 301. The example web browser 301 includes three tabs 301, 302 and 303. Tab 301 is illustrated as being the selected tab. As illustrated, when selected, tab 301 displays a task bar 304 having one or more navigation buttons and an address bar. The tab 301 further includes a display area displaying a main page 305. The main page 305 is illustrated as displaying a system-generated dynamic set of access points 306. The set of access points includes six access points 307-312 where access points 307, 309 and 312 are access points corresponding to web pages and access points 307, 309, 310 and 311 correspond to web applications. The web applications and web pages corresponding to each of the access points 307-312 may belong to a single category (e.g., most visited, recently closed, etc.) or may be selected based on belonging to one or more categories. Additionally, the main page 305 may display navigation mechanisms for navigating to different pages within the tab 301. A first navigation icon 313 is illustrated as being selected and corresponds to the main page. Two additional navigation icons 314 and 315 are displayed in dashed lines. The two additional navigation icons 314 and 315 are selectable to provide the user with means to advance to different pages (e.g., to generate or view additional system-generated or user-generated sets of access points).

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

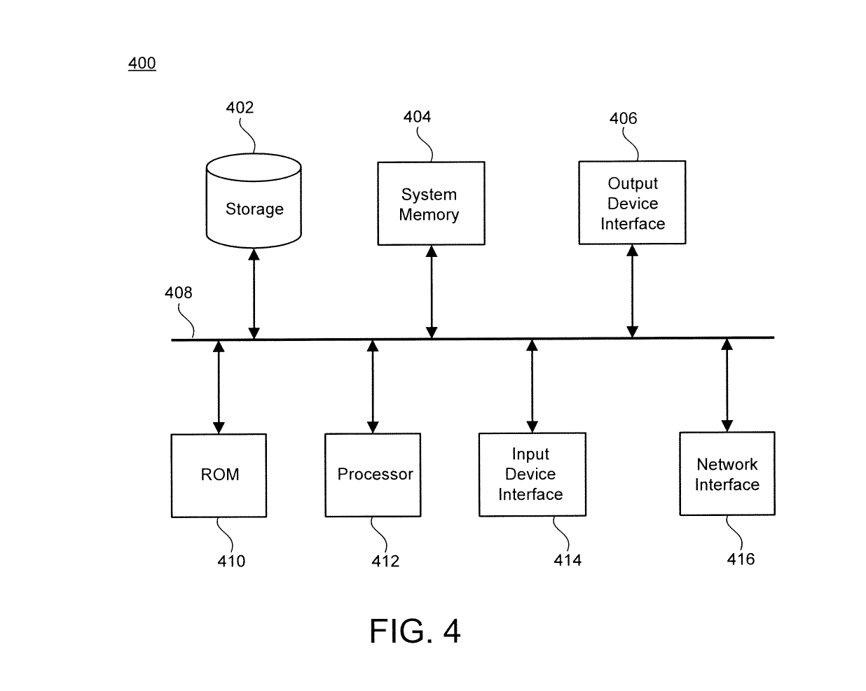

FIG. 4 conceptually illustrates an electronic system with which some implementations of the subject technology are implemented. Electronic system 400 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. For example, the various memory units include instructions for providing a user with a dynamic system-generated set of access points. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A machine-implemented method for providing a dynamic system-generated set of access points to a user, the method comprising:
determining at least one web application or one web page to include within a set of access points according to a set of criteria, the set of criteria including whether the at least one web page or web application belongs in one or more categories, each category including one or more web pages or web applications assigned to the category based on information regarding user behavior with respect to one or more web pages or web applications;
automatically generating an access point for the determined at least one web application or one web page;
adding the generated access point to the set of access points such that the set of access points includes at least one access point corresponding to a web page selected according to the set of criteria and at least one access point corresponding to a web application selected according to the set of criteria; and
providing the set of access points for display to a user in a first page of a web browser, wherein the set of access points are provided for display as icons graphically representing each web page or web application.

2. The method of claim 1, wherein the one or more categories include most visited, which includes one or more web pages or web applications that have been most visited by the user within a specified period of time.

3. The method of claim 1, wherein the one or more categories include recently closed, which includes one or more web pages or web applications that have closed by the user within a specified period of time.

4. The method of claim 1, wherein the one or more categories include most popular, which includes one or more web pages or web applications that have been most visited by the user and one or more other users within a specified period of time.

5. The method of claim 1, wherein the one or more categories include recently updated, which includes one or more web pages or web applications that have been updated within a specified period of time.

6. The method of claim 1, wherein the at least one web application or one web page belongs in at least one of the one or more categories.

7. The method of claim 1, wherein the generating step comprises:
accessing at least a first image associated with the web page or web application;
extracting one or more colors from the first image; and
generating the access point, the access point including a graphical representation of the first image and a border, the border including at least one of the one or more colors, wherein the at least one of the one or more colors is determined to be representative of the first page.

8. The method of claim 1, wherein the determining step is performed in response to receiving an indication of a request to display the set of access points.

9. The method of claim 1, further comprising dynamically updating the set of access points.

10. The method of claim 1, further comprising:
identifying a second set of access points including one or more access points associated within web pages and web applications associated with the user; and
displaying the second set of access points in a second page of the web browser.

11. (canceled)

12. The method of claim 10, wherein the one or more access points of the second set of access points are selected by the user.

13. The method of claim 1, wherein the user is given limited control over the set of access points.

14. A system for optimizing the displaying of a rich web document to a user, the system comprising:
one or more processors; and
a machine-readable medium comprising instructions stored therein, which when executed by the processors, cause the processors to perform operations comprising:
determining at least one web application and one web page to include within a set of access points, wherein the at least one web page and one web application each belong in one or more categories, each category including one or more web pages or web applications assigned to the category based on information regarding user behavior with respect to one or more web pages or web applications;
automatically generating an access point for each of he determined at least one web application and one web page;
adding the generated access point to the set of access points such that the set of access points includes at least one access point corresponding to a web page selected according to the set of criteria and at least one access point corresponding to a web application selected according to the set of criteria; and
providing the set of access points for display to a user wherein the set of access points are provided for display as icons graphically representing each web page or web application.

15. The system of claim 14, wherein the one or more categories include at least one of most visited web pages or web applications, recently user web pages or web applications, recently closed web pages or web applications, most popular web pages or web applications or recently updated web pages or web applications.

16. The system of claim 14, further comprising:
a memory for storing the one or more web pages or web applications belonging to each of the one or more categories in association with each of the one or more categories.

17. The system of claim 14, the operations further comprising:
identifying a second set of access points including one or more access points associated within web pages and web applications associated with the user, wherein the second set of access points corresponds to web page and web applications selected by the user; and
providing the second set of access points for display to the user in a different area from an area displaying the set of access points.

18. The system of claim 14, wherein the user is given limited control over the set of access points.

19. The system of claim 14, wherein the generating step comprises:
accessing at least a first image associated with the web page or web application;
extracting one or more colors from the first image, wherein the one or more colors are determined to be representative of the first page; and
generating the access point, the access point including a graphical representation of the first image and a border, the border including at least one of the one or more colors.

20. A non-transitory machine-readable medium comprising instructions stored therein, which when executed by a machine, cause the machine to perform operations comprising:
determining at least one web application and one web page to include within a set of access points according to a set of criteria, the set of criteria including whether the at least one web page or web application belongs in one or more categories, each category including one or more web pages or web applications assigned to the category based on information regarding user behavior with respect to each of the one or more web pages or web applications;
automatically generating a first access point for the determined at least one web application;
generating a second access point for the determined at least one web page;
adding the generated access point to the set of access points such that the set of access points includes at least one access point corresponding to a web page selected according to the set of criteria and at least one access point corresponding to a web application selected according to the set of criteria; and
providing the set of access points for display to a user in a first page of a web browser, wherein the user is given limited control over the displayed set of access points, wherein the set of access points are provided for display as icons graphically representing each web page or web application.
